(19) United States
(12) Patent Application Publication
(10) Pub. No.: US 2026/0189919 A1
(43) Pub. Date: Jul. 2, 2026

(54) Systems and Methods for Inactive Number Message Governance

(71) Applicant: T-Mobile Innovations LLC, Overland Park, KS (US)

(72) Inventors: Jason HAYES, Lynnwood, WA (US); Sean HOELZLE, Collegeville, PA (US)

(21) Appl. No.: 19/008,552

(22) Filed: Jan. 2, 2025

(51) Int. Cl. H04W 12/72; H04W 12/122

(52) U.S. Cl. CPC H04W 12/72; H04W 12/122

(57) ABSTRACT

A method comprises receiving an Application-to-Peer (A2P) message, wherein the A2P message comprises a destination Mobile Station International Subscriber Directory Number (MSISDN), transmitting via the service delivery gateway and aggregator system, a stop message to the sender system when the destination MSISDN is inactive and currently not attached to an active line of a subscriber associated with the core network system, and instructing, by the honeypot application, performance of a governance action with respect to the sender system based on a rule.

### CROSS-REFERENCE TO RELATED APPLICATIONS

None.

### STATEMENT REGARDING FEDERALLY SPONSORED

### RESEARCH OR DEVELOPMENT

Not applicable.

REFERENCE TO A MICROFICHE APPENDIX

Not applicable.

### BACKGROUND

Application-to-peer (A2P) messages are automated short messaging service (SMS) or multimedia messaging service (MMS) messages sent from applications to users, typically used for notifications, marketing, authentication codes, and customer service updates. A2P messages may sometimes pass through an aggregator system, which may serve to route the messages from the application to the recipient’s mobile network. User devices may receive A2P messages for various reasons. For example, users may have signed up for a service or opted-in to receive notifications, which may trigger an application to send periodic A2P messages to a registered phone number of the user. The user device may thus periodically receive A2P messages from a number of sender systems via aggregator systems.

### SUMMARY

In an embodiment, a method implemented in a communication network to govern message transmissions to inactive numbers is disclosed. The method comprises receiving, by a service delivery gateway executing at a core network system in the communication network from a sender system via an aggregator system, an Application-to-Peer (A2P) message, in which the A2P message comprises a destination Mobile Station International Subscriber Directory Number (MSISDN), a sender identifier, and a message body, and querying, by the service delivery gateway, a state data store to determine that a status of the destination MSISDN indicates that the destination MSISDN is inactive and currently not attached to an active line of a subscriber associated with the core network system. The method further comprises logging, by a honeypot application executing at the core network system, in an incoming message log stored at a data store, metadata associated with the A2P message and an indication that the A2P message is destined for an inactive destination MSISDN, and transmitting, by the honeypot application via the service delivery gateway and aggregator system, a stop message to the sender system, in which the stop message includes a request for at least one of the sender system or the aggregator system to stop sending messages to the destination MSISDN. The method further comprises receiving, by the service delivery gateway from the sender system via the aggregator system, a subsequent A2P message after transmitting the stop message, wherein the subsequent A2P message comprises the destination MSISDN, determining, by the honeypot application, a governance action to perform with respect to the sender system based on a rule after receiving the subsequent A2P message, in which the rule is based on a quantity of subsequent A2P messages comprising the destination MSISDN received from the sender system and indicated in the incoming message log, and instructing, by the honeypot application, performance of the governance action with respect to the sender system.

In another embodiment, a core network system is disclosed. The core network system comprises one or more memories, one or more processors coupled to the one or more memories, a service delivery gateway stored at one or more of the one or more memories, and a honeypot application stored at one or more of the one or more memories. The service delivery gateway, when executed by one or more of the one or more processors, causes the service delivery gateway to be configured to receive an Application-to-Peer (A2P) message from a sender system via an aggregator system, in which the A2P message comprises a destination Mobile Station International Subscriber Directory Number (MSISDN), a sender identifier, and a message body, and determine, using a state data store, a status of the destination MSISDN, wherein the status of the destination MSISDN indicates that the destination MSISDN is inactive and currently not attached to an active line of a subscriber. The honeypot application, when executed by one or more of the one or more processors, causes the service delivery gateway to be configured to log, in an incoming message log stored at a data store, metadata associated with the A2P message and an indication that the A2P message is destined for an inactive destination MSISDN, and transmit, via the service delivery gateway and aggregator system, a stop message to the sender system, wherein the stop message includes a flag instructing at least one of the sender system or the aggregator system to stop sending messages to the destination MSISDN.

In yet another embodiment, a method is disclosed. The method comprises receiving, by a service delivery gateway executing at a core network system in a communication network from a sender system via an aggregator system, an Application-to-Peer (A2P) message, in which the A2P message comprises a destination Mobile Station International Subscriber Directory Number (MSISDN), a sender identifier, and a message body, transmitting, by a honeypot application executing at the core network system, via the service delivery gateway and aggregator system, a stop message to the sender system when the destination MSISDN is inactive and currently not attached to an active line of a subscriber associated with the core network system, in which the stop message includes a flag instructing at least one of the sender system or the aggregator system to stop sending messages to the destination MSISDN, and instructing, by the honeypot application, performance of a governance action with respect to the sender system based on a rule, in which the rule is based on a quantity of subsequent A2P messages with the destination MSISDN that the sender system has transmitted messages to the core network system.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network according to an embodiment of the disclosure.

FIG. 2 is a message sequence diagram illustrating a method of inactive number message governance in the communication network of FIG. 1 according to various embodiments of the disclosure.

FIG. 3 is a message sequence diagram illustrating a second method of inactive number message governance in the communication network of FIG. 1.

FIG. 4 is a flowchart of a third method of inactive number message governance according to various embodiments of the disclosure.

FIG. 5 is a flowchart of a fourth method of inactive number message governance according to various embodiments of the disclosure.

FIG. 6 is a block diagram of a computer system implemented within the communication network of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As mentioned above, user devices or user equipment (UE) may periodically receive A2P messages from sender systems via aggregator systems. A sender system may refer to the information technology (IT) infrastructure hosting applications/platforms that manage and dispatch A2P messages on behalf of businesses or organizations. A user may have opted-in to receive text messages from the business or organization using an MSISDN (also sometimes referred to herein as “phone number”) owned by the user.

However, after opting-in to receive A2P messages using the MSISDN, the user may relinquish the MSISDN for varying reasons. For example, the user may deactivate or disconnect the MSISDN to receive a new MSISDN for personal reasons (e.g. lifestyle change, switching to a family plan, using only a work-provided number, etc.). After a MSISDN is relinquished by a user, the relinquished MSISDN is stored in a data store for a holding period managed by the telecommunications service provider, which prevents the MSISDN from immediate reassignment. This holding period, sometimes lasting from 30 to 90 days (depending on the region and the provider), helps ensure that any lingering calls, texts, or services tied to the relinquished MSISDN are properly disconnected to minimize privacy issues. After the holding period ends, the MSISDN may be placed into a pool of available MSISDNs, from which the MSISDN is permitted to be reassigned to a new user. This recycling process allows telecommunication service providers to efficiently manage and reuse limited numbering resources.

However, when an MSISDN is in the holding period or in the pool of available numbers, the sender systems and aggregator systems may continue to transmit A2P messages to the MSISDN. This may be because the sender system and aggregator system are not aware the user has relinquished the MSISDN, and thus the prior opt-in for A2M messages with the MSISDN is no longer valid. In other cases, the relinquished MSISDN may be indicated in an inactive MSISDN list (also referred to as a “cancellation feed”), which may include the inactive MSISDNs that are in the holding period or in the pool of available numbers. However, the sender system and/or aggregator system may not review the inactive MSISDN list prior to sending A2P messages to MSISDNs that may be included in the inactive MSISDN list. The term “relinquished MSISDN” is also referred to herein as an “inactive MSISDN” or a “deactivated MSISDN.”

In either case, a network element (e.g., service delivery gateway (SDG)) in a core network, associated with the provider to which the inactive MSISDN was attached, may receive the A2P message with the inactive MSISDN as the destination identifier/address. The network element in the core network may access a database to determine that the MSISDN in the A2P message is inactive (e.g., is currently in a holding period after being relinquished or in the pool of available numbers). If inactive, the network element may return an error message to the aggregator system and sender system. For example, the error message may simply indicate that the MSISDN indicated in the destination identifier/address cannot be reached.

Therefore, when the aggregator system and sender system receive the error message, the aggregator system and sender system may simply assume that the MSISDN is temporarily unavailable, or some other error has occurred, and thus the aggregator system and sender system may continue sending A2P messages to the MSISDN. Said another way, the error message received from the network element in the core network may have no indication that the MSISDN has been relinquished or is otherwise inactive. As such, the sender system and aggregator system may continue to repeatedly transmit A2P messages to inactive, relinquished MSISDNs because the sender system and the aggregator system are unaware of the state of the MSISDN (i.e., that the MSISDN is inactive). This causes sender systems and aggregator systems to flood the network with A2P messages destined for inactive MSISDNs, and in turn cause the core network to flood the network with error messages related to the same inactive MSISDN. Therefore, the aforementioned transmission of A2P messages being sent to inactive MSISDNs and non-descript error messages being sent in response to the A2P messages causes the technical problem of significantly reducing network capacity by flooding the network with unnecessary data traffic.

The present disclosure addresses the foregoing technical problems by providing a technical solution in the technical field of network transmissions and MSISDN management at the core network. The embodiments disclosed herein are directed to transmitting a stop message with a request/instruction for the sender system and aggregator system to stop transmitting A2P messages (or any other type of message (e.g., SMS, MMS, etc.)) to inactive MSISDNs (instead of a non-descript error message). The embodiments disclosed herein also govern the transmission of A2M messages from different sender systems and aggregator systems to inactive MSISDNs, and perform governance actions as necessary based on whether the sender systems and aggregator systems are compliant with previously sent stop messages. In this way, the embodiments disclosed herein greatly reduce network traffic by preventing the flooding of A2P messages to inactive MSISDNs and preventing the flooding of redundant error messages to sender systems and aggregator systems in the network, thereby increasing network capacity.

In the embodiments disclosed herein, a communication network including one or more sender systems, one or more aggregator systems, and a core network interwork to govern message transmissions to inactive numbers. The core network is the central part of a telecommunications network managed by a service provider, responsible for routing calls, data, and SMS traffic between users and external networks. Users that are subscribed with the service provider may have subscriber profiles stored at the core network, in which the subscriber profiles may indicate one or more active MSISDNs linked to different lines or accounts associated with the user. Each MSISDN may be linked to a subscriber identity module (SIM) (e.g., either a SIM card or an electronic-SIM (eSIM) profile) when the MSISDN is actively registered with line associated with a user.

As mentioned above, a sender system includes the IT infrastructure, platforms, and applications that originate A2P messages often managed by business or organizations to send notifications, alerts, or promotional content to users. Sender systems may generate and format A2P message content, and then use application programming interfaces (APIs) to interface with messaging gateways (e.g., aggregator systems), to ensure that A2P messages are transmitted to the destination MSISDN. The aggregator systems act as intermediaries between sender systems and the core network associated with a telecommunications service provider. The aggregator systems route A2P messages through the appropriate network providers based on the destination MSISDNs.

The core network may include various hardware and software network elements that serve to perform various functions for routing calls and messages on behalf of users. For example, the network element in the core network may be a service delivery gateway (SDG), short message service center (SMSC), and/or multimedia messaging service center (MMSC), any of which may be a central point for managing and routing A2P messages through the network. In the example described herein, the network element in the core network that evaluates the A2P messages to govern transmission of the A2P message is the SDG. However, it should be appreciated that the network element may be any other software application or function available at the core network (e.g., the SMSC and/or the MMSC).

The SDG may act as a bridge between sender systems/aggregator systems and the core network internal systems, by handling A2P message and data routing. The SDG may receive A2P messages from one or more sender systems, in some cases, via one or more aggregator systems. The A2P messages may include, for example, at least one of a destination MSISDN, a sender identifier identifying the sender system, an aggregator identifier identifying the aggregator system, and a message body. The SDG may then query a state database to determine a status of the destination MSISDN. The state database may be a database stored in a data store of the core network or otherwise accessible to the core network. The state database may include mappings between MSISDNs and an indication (e.g., flag) of whether the MSISDN is active (e.g., currently associated with an active line of a subscriber profile at the core network) or inactive (e.g., currently not associated with an active line of a subscriber profile at the core network – because the MSISDN has been relinquished by a user and is either in the holding period or in the available number pool). The SDG may query the state database with the destination MSISDN from the A2P message to obtain a most up-to-date status of the destination MSISDN.

When the status of the destination MSISDN indicates that the destination MSISDN is inactive and not currently attached to an active line of a subscriber profile, the SDG may forward the A2P message to a honeypot application at the core network. The honeypot application may be software tool executable at a computer system of the core network, and may serve as a security tool for detecting and governing the transmission of unauthorized A2P messages destined for inactive MSISDNs. The honeypot application may log metadata associated with (e.g., describing) the A2P message in an incoming message log stored at a data store in or accessible by the core network. The metadata associated with the A2P message may include, for example, a sender identifier identifying the sender system (or application/service in the sender system) of the A2P message, an aggregator identifier identifying the aggregator system that forwarded the A2P message, the destination (or recipient) MSISDN in the A2P message, a message type of the A2P message (e.g., promotional, translational, or informational), timestamp of the A2P message, a current delivery status of the message (e.g., delivered, failed, blocked, pending), message content (e.g., reference or ID associated with the message content), a message identifier for tracking the A2P message, priority level assigned to the A2P message, etc.

Once the honeypot application logs the incoming A2P message destined for an inactive MSISDN, the honeypot application may generate a stop message for transmission to the aggregator system and/or sender system. For example, the stop message may include a request or instruction for the aggregator system and/or sender system to stop transmitting A2P messages to a destination MSISDN. In this way, the stop message may include a field to carry an indication (e.g., flag, bit, value, etc.) indicating that the stop message is the request or instruction to stop sending messages to a recipient, and the stop message may include a field to carry the inactive destination MSISDN.

The recipient sender system and/or aggregator system of the stop message may be expected to modify the internal programming to prevent future A2P messages from being transmitted to the inactive destination MSISDN carried in the stop message. For example, the sender system and/or aggregator system may maintain a local list of inactive MSISDNs (e.g., based on received stop messages), and the programming at the sender system and/or aggregator system may be modified to only transmit A2P messages to MSISDNs that are not on the local list.

In an embodiment, the honeypot application (or other application/function at the core network) may generate an inactive MSISIDN list including all of the MSISDNs that are currently in the holding period or in the currently available pool of available MSISDNs. The inactive MSISDN list may be stored at a data store in or accessible by the core network and may be publicly available to all sender systems and aggregator systems. In some cases, a sender system and/or aggregator system may be expected to modify the internal programming at the sender system and/or aggregator system to prevent future A2P messages from being transmitted to any of the MSISDNs included in the inactive MSISDN list.

However, there may be cases in which sender systems continue to send A2P messages (and/or aggregator systems that continue to forward A2P messages) to inactive MSISDNs (e.g., either in response to receive a stop message with the inactive MSISDN or when the inactive MSISDN is indicated in the publicly available inactive MSISDN list). In this case, the honeypot application may be programmed to perform one or more governance actions with respect to the sender systems and/or aggregator systems based on one or more rules. The one or more rules may be based on various factors, such as, for example, a quantity of stop messages with an MSISDN sent to the sender system/aggregator system, a quantity of A2P messages received from the sender system/aggregator system after having sent a single stop message to the sender system/aggregator system, whether the sender system/aggregator system previously received a stop message, whether the MSISDN is included in an inactive MSISDN list, a priority of the sender system/aggregator system (e.g., based on type of messages sent by the sender system/aggregator system or the type business/organization behind the sender system), etc.

A rule may indicate that a governance action be performed based on one or more of the aforementioned factors or based on whether one or more conditions are met. For example, a governance action may include generating a report detailing one or more subsequent A2P messages received by the honeypot application destined for the MSISDN after transmitting the stop message with the MSISDN (e.g., in which the report details a quantity of subsequent A2P messages received with the MSISDN as the destination, details on the sender system/aggregator system, etc.). As another example, a governance action may include blocking subsequent messages received by the sender system and/or aggregator system (or adding to a blocklist), throttling subsequent messages received by the sender system and/or aggregator system, and/or imposing rate limits on messages received from the sender system and/or aggregator system. As yet another example, a governance action may include invoicing (e.g., by a billing system of the core network) the sender system and/or aggregator system for the subsequent A2P messages with the MSISDN. As yet another example, a governance action may include reducing a reputation score associated with the sender system and/or aggregator system, in which the reputation score may affect a priority allotted to the transmission of messages received from the sender system and/or aggregator system (e.g., lower reputation scores have a lower priority for data transmissions in the network, and higher reputation scores have a higher priority for data transmissions in the network), and/or affect other governance actions performed with respect to the sender system and/or aggregator system. In an embodiment, the governance action may include generating a report of top offender sender systems and/or aggregator systems that ignore at least a threshold number of stop messages and continue to transmit A2P messages to inactive MSISDNs, and/or adding the top offender sender systems and/or aggregator systems to a blocklist (e.g., to block all messages received from top offender sender systems and/or aggregator systems).

When an A2P message is received by the honeypot application (e.g., from the SDG after determining that the A2P message includes an inactive MSISDN), the honeypot application may first determine whether the inactive MSISDN carried in the A2P message is included in the publicly available inactive MSISDN list. One or more rules may define a governance action based solely on whether the inactive MSISDN carried in the A2P message is included in the publicly available inactive MSISDN list (e.g., the governance action may be to reduce the reputation score of the sender system and/or aggregator system). The honeypot application may then determine whether a stop message carrying the inactive MSISDN was previously and recently (e.g., within the past 30-90 days) sent to the sender system and/or aggregator system. One or more rules may define a governance action based on whether the inactive MSISDN carried in the A2P message is included in the publicly available inactive MSISDN and/or based on whether a stop message carrying the inactive MSISDN was previously and recently sent to the sender system and/or aggregator system. The honeypot application may also determine a quantity of prior stop messages with the inactive MSISDN sent to the sender system and/or aggregator system, and a quantity of messages with the inactive MSISDN received from the sender system and/or aggregator system. One or more rules may define a governance action further based on the quantity of prior stop messages sent and/or the quantity of received messages with the inactive MSISDN.

In this way, the embodiments disclosed herein serve to conserve network capacity, and processing and power resources by reducing the flooding of A2P messages with inactive MSISDNs in the network and eliminating the need to send repetitive error messages in response to the A2P messages with inactive MSISDNs. To this end, the embodiments disclosed herein have a relatively light footprint because the computations are all performed at the core network, using data maintained by the core network (e.g., MSISDN statuses and inactive MSISDN list). Moreover, by automating the process of notifying the sender systems and/or aggregator system of inactive MSISDNs via stop messages, the transmission of unauthorized and unwanted messages with no destination may be prevented. Therefore, in general, the embodiments disclosed herein serve to increase network capacity by decreasing the transmission of unwanted messages in the network.

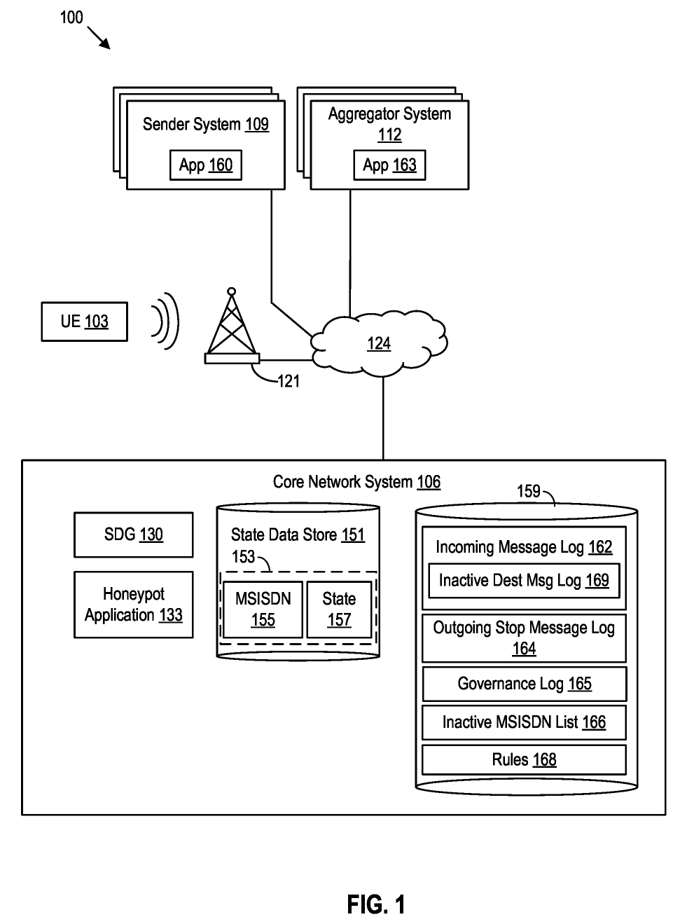

Turning now to FIG. 1, a communication network 100 is described. The communication network 100 shown in FIG. 1 includes a UE 103, a core network system 106, a sender system 109, an aggregator system 112, a cell site 121, and a network 124. The network 124 may be one or more private networks, one or more public networks, or a combination thereof. The cell site 121 refers to a physical location equipped with antennas and other radio equipment that enables wireless communication between UE 103, core network system 106, sender system 109, and aggregator system 112.

The UE 103 may refer to any device that connects to the network 123 via the cell site 121 to access services and communicate with the core network system 106 via a radio access network (RAN). Examples of UE 103 include smartphones, tablets, laptops, Internet of Things (IoT) devices, wearable devices, etc.

The sender system 109 may be a collection of hardware and software resources (e.g., distributed or co-located servers with computing and memory resources) that run one or more applications 160. The application 160 generates and formats an A2P message (e.g., based on a user of the UE 103 having previously opted-in for messages from a business or organization associated with the sender system 109). The A2P message may include an MSISDN of a line attached the UE 103, a sender identifier identifying the sender system 109, the application 160, and/or the business or organization behind the sender system 109. The application 160 may then transmit (e.g., via APIs) the A2P message to the aggregator system 112.

The aggregator system 112 may be a collection of hardware and software resources (e.g., distributed or co-located servers with computing and memory resources) that run one or more applications 163. The aggregator system 112 may act as an intermediary between the sender system 109 and the core network system 106. The application 163 may receive the A2P message from the sender system 109, determine the appropriate telecommunications service provider core network system 106 to which to route the A2P message based on the destination MSISDN included in the A2P message, and then route the A2P message to the identified core network system 106.

The core network system 106 may be the central telecommunications infrastructure for managing and routing data, voice, and signaling traffic between various UE 103, sender system 109, and aggregator system 112. The core network system 106 may be communicatively coupled to the RAN, which may be the telecommunications network that connects the UE 103, sender system 109, and aggregator system 112 to the core network system 106 via radio waves. The RAN may include the cell site 121, base stations, antennas, and other network elements (NE) (e.g., routers, switches, bridges, virtual networks, etc.) that manage the transmission and reception of wireless signals.

As shown in FIG. 1, the core network system 106 may include various network elements (e.g., applications, artifacts, and/or functions) executable at a computer system of the core network system 106. The network elements include the SDG 130 and honeypot application 133, each of which may be instructions stored on a memory of the core network system 106 and executable by a processor of the core network system 106. The network elements may also include an SMSC and an MMSC, each of which may perform functions similar to the SDG 130 as disclosed herein.

The SDG 130 may receive A2P messages directly from the sender system 109 or indirectly from the sender system 109 via the aggregator system 112. The SDG 130 may also determine a state of the destination MSISDN carried in the A2P message, and forward the message to the honeypot application 133 when the state of the destination MSISDN is inactive (e.g., in the holding period or in the available number pool). The honeypot application 133 may generate and send a stop message to the sender system 109 and/or aggregator system 112 (depending upon whether the sender system 109 or the aggregator system 112 sent the A2P message). The honeypot application 133 may also be responsible for governing the transmission of A2P messages to inactive MSISDNs, as further described herein.

The core network system may also include the state data store 151 (e.g., one or more memories) and the data store 159 (e.g., one or more memories). The state data store 151 may include MSISDN-to-state mappings 153, which may indicate a state 157 of each of the MSISDNs 155 associated with the core network system 106. An MSISDN 155 is associated with the core network system 106 when an MSISDN 155 is allocated to the telecommunications service provider operating the core network system 106 (e.g., by national or regional telecommunications regulatory authorities). For example, the state 157 for each MSISDN 155 may indicate whether the MSISDN 155 is active (e.g., currently associated with an active line in a subscriber profile at the core network system 106) or inactive (e.g., currently not associated with an active line in a subscriber profile at the core network system 106 – a relinquished MSISDN 155 in a holding period or in a pool). As used herein, the term “MSISDN” may sometimes be referred to as “device identifier” or “phone number.”

The data store 159 may maintain an incoming message log 162, an outgoing stop message log 164, governance log 165, an inactive MSISDN list 166, and rules 168. The incoming message log 162 may store metadata associated with (e.g., describing) all incoming messages (e.g., A2P messages) received at the core network system 106. The metadata associated with the A2P message may include, for example, a sender identifier identifying the sender system 109 (or application 160 in the sender system 109) of the A2P message, an aggregator identifier identifying the aggregator system 112 that forwarded the A2P message, the destination (or recipient) MSISDN 155 in the A2P message, a message type of the A2P message (e.g., promotional, translational, or informational), timestamp of the A2P message, a current delivery status of the A2P message (e.g., delivered, failed, blocked, pending), message content (e.g., reference or identifier associated with the message content), a message identifier for tracking the A2P message, priority level assigned to the A2P message, etc. The incoming message log 162 may also include an inactive destination message log 169. The inactive destination message log 169 may include metadata describing the incoming messages with destination MSISIDNs 155 that are currently in an inactive state 157. Said another way, the incoming message log 162 maintains metadata describing incoming messages with destination MSISIDNs 155 that are currently in an inactive state 157.

The outgoing stop message log 164 may include metadata associated with the stop messages sent by the honeypot application 133. The metadata associated with the stop messages may include, for example, an identifier of the core network system 106 sending the stop message, an aggregator identifier identifying the aggregator system 112 to which the stop message is sent, a sender identifier identifying the sender system 109 to which the stop message is sent, timestamp of sending the stop message, a current delivery status of the stop message (e.g., delivered, failed, blocked, pending), the MSISDN carried in the stop message, a message identifier for tracking the stop message, other data carried in the stop message, etc.

The governance log 165 may include data describing governance actions performed by the honeypot application 133 and/or the rules 168 applied to determine the appropriate governance action. The governance log 165 may include data such as, for example, the satisfied conditions leading to the performance of a governance action, a type of governance action performed, the sender system 109 and/or aggregator system 112 upon which the governance action was performed, a timestamp of performing the governance action, an identification of the rules 168 applied to determine the governance action, the inactive MSISDN, any data computed to determine the governance action (e.g., quantity of prior stop messages with the inactive MSISDN, the quantity of A2P messages from the sender system 109 and/or aggregator system 112 carrying the inactive MSISDN, etc.), etc. The rules 168 may refer to logic, code, and/or conditions that define one or more governance actions to perform with respect to a sender system 109 and/or aggregator system 112 based on one or more conditions being met.

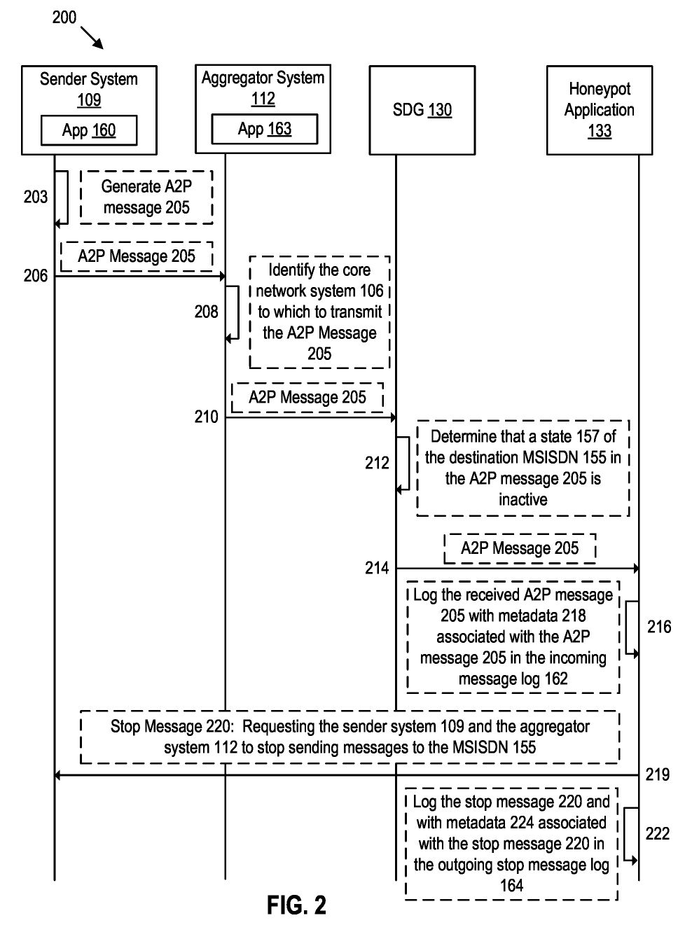

Referring now to FIG. 2, shown is a message sequence diagram illustrating a method 200 of message governance in the communication network 100 of FIG. 1 according to various embodiments of the disclosure. Method 200 may be performed by the application 160 of the sender system 109, the application 163 of the aggregator system 112, the SDG 130 (or any other network element/function at the core network system 106), and the honeypot application 133.

At operation 203, the application 160 at the sender system 109 may generate an A2P message 205. In some cases, the application 160 may be configured to generate an A2P message 205 for a destination MSISDN 155 based on one or more triggers. The triggers may include, for example, account activity alerts (e.g., banks and financial institutions may send A2P messages 205 when unusual account activity is detected), two-factor authentication (e.g., a second factor of authentication may be sent in an A2P message as an added security step to verify identity), appointment reminders (e.g., from medical offices, salons, service providers), order/shipping confirmations and updates, programs and promotions, payment reminders and receipts, customer feedback requests, etc.

To generate the A2P message 205, the application 160 may use predefined templates with personalized data and automation rules to create a message tailored for the recipient operating the destination MSISDN 155. The A2P message 205 may include an identifier of the sender system 109, application 160, and/or business or organization behind the sender system 109/application 160 (e.g., an alphanumeric identifier), an identifier of the aggregator system 112 to which the A2P message 205 will be sent (e.g., an alphanumeric identifier) the destination MSISDN 155 identifying the destination phone number to which the A2P message 205 is to be sent, metadata (e.g., timestamp, message identifier, priority levels, etc.), and a message body (e.g., main text or multimedia with the primary content of the A2P message 205).

At operation 206, once the A2P message 205 is composed, the application 160 may transmit the A2P message 205 to the aggregator system 119, which handles routing through the telecommunications network (e.g., network 124) to the core network system 106 associated with the destination MSISDN 155 in the A2P message 205, to ultimately ensure that the A2P message 205 reaches the intended recipient. At operation 208, the application 163 at the aggregator system 112 may identify the core network system 106 to which to transmit the A2P message 205 (taking into account network traffic, routing paths, and network compliance for transmission of the A2P message 205). The application 163 may identify the core network system 106 to which transmit the A2P message 205 based on the destination MSISDN 155 carried in the A2P message 205. For example, the application 163 may query one or more databases that map MSISDNs 155 to their associated telecommunications service providers, and thus the core network system 106 of the associated telecommunications service provider. For example, the application 163 may perform a real-time lookup through a third-party service or in-house database that identifies the core network system 106 for the destination MSISDN 155. By correctly identifying the recipient’s telecommunications service provider, the aggregator system 112 may route the A2P message 205 through the appropriate network path to optimize delivery success and reduce errors. At operation 210, the application 163 may transmit the A2P message 205 to the identified core network system 106.

The SDG 130 (or the SMSC or MMSC) at the core network system 106 may then perform operation 212 to determine that a state 157 of the destination MSISDN 155 in the A2P message 205 is inactive. For example, the SDG 130 may query the state data store 151 and search through the MSISDN-to-state mappings 153 to identify the destination MSISDN 155 and the most up-to-date state 157 of the destination MSISDN 155 as recorded in the state data store 151. In this case, the state 157 may indicate (e.g., as a bit, flag, or value) that the destination MSISDN 155 is in an inactive state 157, meaning that the destination MSISDN 155 is currently not associated with an active line of a subscriber profile at the core network system 106, and instead may be in a holding period (after user MSISDN relinquishment) or in a pool of available MSISDNs. When the SDG 130 determines that the state 157 of the destination MSISDN 155 is inactive, the SDG 130 may perform operation 214 to forward the A2P message 205 to the honeypot application 133 for further processing and governance.

At operation 216, the honeypot application 133 may log metadata 218 describing the A2P message 205 into the incoming message log 162. The metadata 218 associated with the A2P message 205 may include, for example, a sender identifier identifying the sender system 109 (or application 160 in the sender system 109) of the A2P message 205, an aggregator identifier identifying the aggregator system 112 that forwarded the A2P message 205, the destination (or recipient) MSISDN 155 in the A2P message 205, a message type of the A2P message 205 (e.g., promotional, translational, or informational), timestamp of the A2P message 205, a current delivery status of the A2P message 205 (e.g., delivered, failed, blocked, pending), message content (e.g., reference or ID associated with the message content), a message identifier for tracking the A2P message 205, priority level assigned to the A2P message 205, etc. In particular, this metadata 218 may be logged in the inactive destination message log 169.

At operation 219, the honeypot application 133 may generate and transmit a stop message 220 to the sender system 109 and/or the aggregator system 109. The stop message 220 may include a request or instruction for the aggregator system 112 and/or sender system 109 to stop transmitting A2P messages 205 to a destination MSISDN 155. For example, the stop message 220 may include a field to carry an indication (e.g., flag, bit, value, etc.) indicating that the stop message 220 is the request or instruction to stop sending messages to a particular recipient, and the stop message 220 may include a field to carry the inactive destination MSISDN 155.

After sending the stop message 220, the honeypot application 133 may perform operation 222 to log the transmission of the stop message 220 and metadata 224 describing the stop message 220 in the outgoing stop message log 164. The metadata 224 associated with the stop message 220 may include, for example, an identifier of the core network system 106 sending the stop message 220, an aggregator identifier identifying the aggregator system 112 to which the stop message 220 is sent, a sender identifier identifying the sender system 109 to which the stop message 220 is sent, timestamp of sending the stop message 220, a current delivery status of the stop message 220 (e.g., delivered, failed, blocked, pending), the destination MSISDN 155 carried in the stop message 220, a message identifier for tracking the stop message 220, other data carried in the stop message 220, etc.

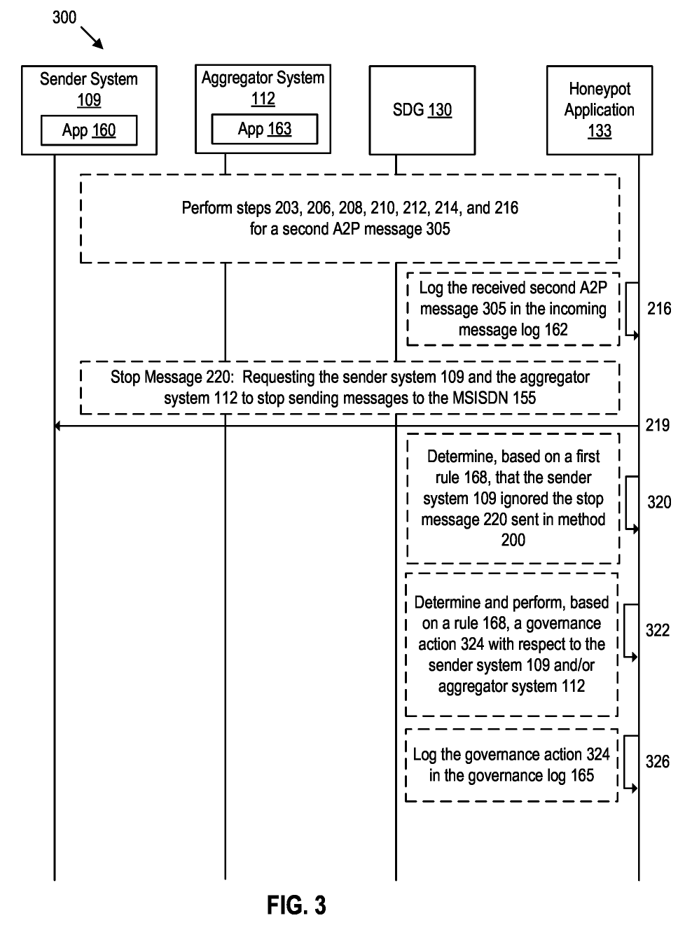

Referring now to FIG. 3, shown is a message sequence diagram illustrating a second method 300 of message governance in the communication network 100 of FIG. 1 according to various embodiments of the disclosure. Method 300 may be performed by the application 160 of the sender system 109, the application 163 of the aggregator system 112, the SDG 130 (or any other network element/function at the core network system 106), and the honeypot application 133.

Method 300 may begin after method 200, when the sender system 109 and/or aggregate system 112 has already received a stop message 220 with the destination MSISDN 155. However, in the example shown in FIG. 3, the sender system 109 may continue sending one or more subsequent A2P messages 305 with the same destination MSISDN 155, even after having received the stop message 220 with the destination MSISDN 155. Therefore, as shown in FIG. 3, method 300 may begin with the sender system 109, aggregator system 112, SDG 130, and/or honeypot application 133 performing operations 203, 206, 208, 210, 212, 214, and 216 for a second, subsequent A2P message 305. The second A2P message 305 may or may not have a different message body than the A2P message 305. However, the second A2P message 305 may have the same sender identifier, aggregator identifier, and destination MSISDN 155 as the A2P message 205.

As shown in FIG. 3, method 300 may begin after the honeypot application 133 performs operation 216 to log metadata 218 describing the second A2P message 305 in the incoming message log 162. In an embodiment, method 300 may include operation 219, in which the honeypot application 133 generates, sends, and logs the stop message 220 to the sender system 109 and/or the aggregator system 112. Again, the stop message 220 may include a request or instruction for the sender system 109 and/or the aggregator 112 to stop sending messages to the destination MSISDN 155. However, in some embodiments, method 300 may not include operation 219, and may instead proceed straight from operation 216 to operation 320.

At operation 320, the honeypot application 133 may determine, based on a first rule 168, that the sender system 109 (and/or the aggregate system 112) ignored the stop message 220, and is thus a repeat offender. For example, the rule 168 may instruct the honeypot application 133 to first determine whether the A2P message 305 with the destination MSISDN 155 is received from a sender system 109 and/or aggregate system 112 after a stop message 220 has already been sent to the sender system 109 and/or aggregate system 112. If the A2P message 305 with the destination MSISDN 155 is received from a sender system 109 and/or aggregate system 112 after a stop message 220 has already been sent to the sender system 109 and/or aggregate system 112, the rule 168 may instruct the honeypot application 133 to perform operation 322.

At operation 322, the honeypot application 133 may determine and perform, based on the rule 168 (or another rule 168) a governance action 324 with respect to the sender system 109 and/or the aggregator system 112. A governance action 324 may refer to one or more actions or tasks to be performed by the honeypot application 133 to penalize the sender system 109 and/or aggregate system 112 for sending the A2P message 305 with the destination MSISDN 155 after a stop message 220 was sent to the sender system 109 and/or aggregate system 112 with the destination MSISDN 155. For example, the rule 168 may indicate that when a quantity of stop messages 220 sent to the sender system 109 and/or aggregate system 112 with the destination MSISDN 155 exceeds a first threshold, and/or when a quantity of A2P messages 205, 305 received from the sender system 109 and/or aggregate system 112 with the destination MSISDN 155 after having received the stop message 220 exceeds a second threshold, the honeypot application 133 is to perform a predefined governance action 324.

For example, a governance action 324 may include generating a report detailing one or more subsequent A2P messages 305 received by the honeypot application 133 with the destination MSISDN 155 after transmitting the stop message 220 with the destination MSISDN 155 (e.g., in which the report details a quantity of subsequent A2P messages 305 received with the destination MSISDN 155, details on the sender system 109/aggregator system 122, etc.). As another example, a governance action 324 may include blocking subsequent A2P messages 305 received by the sender system 109 and/or aggregator system 112 (and/or add to block list), throttling subsequent A2P messages 305 received by the sender system 109 and/or aggregator system 112, and/or imposing rate limits on A2P messages 305 received from the sender system 109 and/or aggregator system 112. As yet another example, a governance action 324 may include invoicing (e.g., by a billing system of the core network system 106) the sender system 109 and/or aggregator 112 system for the subsequent A2P messages 305 with the destination MSISDN 155. As yet another example, a governance action 324 may include reducing a reputation score associated with the sender system 109 and/or aggregator system 112, in which the reputation score may affect a priority provided to the transmission of A2P messages 205, 305 received from the sender system 109 and/or aggregator system 112 (e.g., lower reputation scores have a lower priority for data transmissions in the network, and higher reputation scores have a higher priority for data transmissions in the network), and/or affect other governance actions 324 performed with respect to the sender system 109 and/or aggregator system 112.

Once the honeypot application 133 performs the governance action 324, the honeypot application 133 may proceed to operation 326 to log the governance action 324 in the governance log 165. The governance log 165 may include data such as, for example, a type of governance action performed, the sender system 109 and/or aggregator system 112 upon which the governance action 324 was performed, a timestamp of performing the governance action 324, an identification of the rules 168 applied to determine the governance action 324, the inactive destination MSISDN 155, any data computed to determine the governance action 324 (e.g., quantity of prior stop messages 220 with the inactive destination MSISDN 155, the quantity of A2P messages 205, 305 from the sender system 109 and/or aggregator system 112 carrying the inactive destination MSISDN 155, etc.), etc.

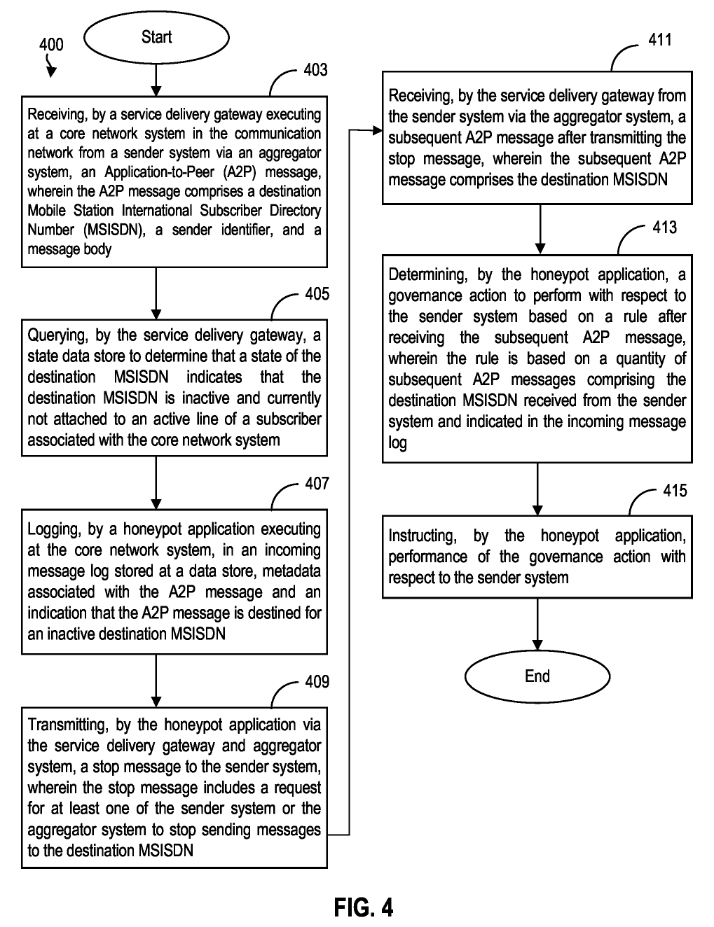

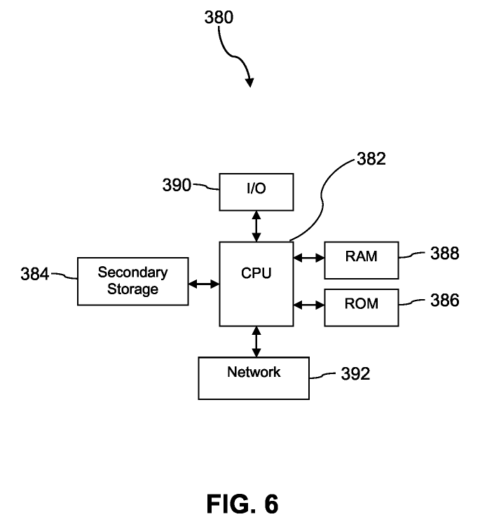

Referring now to FIG. 4, shown is a method 400 of inactive number message governance according to various embodiments of the disclosure. Method 400 may be performed by one or more network elements in the core network system 106 (e.g., the SDG 130 and the honeypot application 133). In embodiments, the method 400 may be implemented using a computer system with components as shown in FIG. 6. As illustrated, method 400 of FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At step 403, method 400 comprises receiving, by an SDG 130 executing at a core network system 106 in the communication network 100, from a sender system 109 via an aggregator system 112, an A2P message 205. The A2P message 205 comprises a destination MSISDN 155, a sender identifier, and a message body.

At step 405, method 400 comprises querying, by the SDG 130, a state data store 151 to determine that a state 157 of the destination MSISDN 155 indicates that the destination MSISDN 155 is inactive and currently not attached to an active line of a subscriber associated with the core network system 106. At step 407, method 400 comprises logging, by a honeypot application 133 executing at the core network system 106, in an incoming message log 162 stored at a data store, metadata 218 associated with the A2P message 205 and an indication that the A2P message 205 is destined for an inactive destination MSISDN 155.

At step 409, method 400 comprises transmitting, by the honeypot application 133 via the SDG 130 and aggregator system 112, a stop message 220 to the sender system 109. The stop message 220 includes a request for at least one of the sender system 109 or the aggregator system 112 to stop sending messages to the destination MSISDN 155. At step 411, method 400 comprises receiving, by the SDG 130 from the sender system 109 via the aggregator system 112, a subsequent A2P message 305 after transmitting the stop message 220. The subsequent A2P message 305 also comprises the destination MSISDN 155.

At step 413, method 400 comprises determining, by the honeypot application 133, a governance action 324 to perform with respect to the sender system 109 based on a rule 168 after receiving the subsequent A2P message 305. The rule 168 is based on a quantity of subsequent A2P messages 305 comprising the destination MSISDN 155 received from the sender system 109 and indicated in the incoming message log 162. At step 415, method 400 comprises instructing, by the honeypot application 133, performance of the governance action 324 with respect to the sender system 109.

Method 400 may include other steps and/or features that are not otherwise shown in FIG. 4. In an embodiment, method 400 may comprise adding, by the honeypot application 133, a second indication in the incoming message log 162 indicating that the sender system 109 ignored an inactive MSISDN list 166 including the destination MSISDN 155, in which the inactive MSISDN list 166 is stored at a database accessible by the sender system 109. In an embodiment, the governance action 324 comprises at least one of generating, by the honeypot application 133, a report detailing one or more subsequent A2P messages 305 received after transmitting the stop message 220, blocking, by the honeypot application 133, all messages received from at least one of the sender system 109 or the aggregator system 112, imposing, by the honeypot applications 133, rate limits on messages received from the sender system 109, invoicing, by the honeypot application 133, a penalty charge to the sender system 109 for the continued transmission of A2P messages 305 to the inactive destination MSISDN 155, or reducing, by the honeypot application 133, a reputation score associated with the sender system 109.

In an embodiment, the state data store 151 comprises a plurality of MSISDNS 155 and an associated active or inactive state 157 for each of the MSISDNs 155. When an MSISDN 155 is associated with an active state 157, the MSISDN 155 is currently attached to the active line of the subscriber, and when the MSISDN 155 is associated with the inactive status, the MSISDN 155 is currently not attached to the active line of the subscriber. In an embodiment, the stop message 220 comprises a flag indicative that the stop message 220 is the request for at least one of the sender system 109 or the aggregator system 112 to stop sending messages 305 to the destination MSISDN 155.

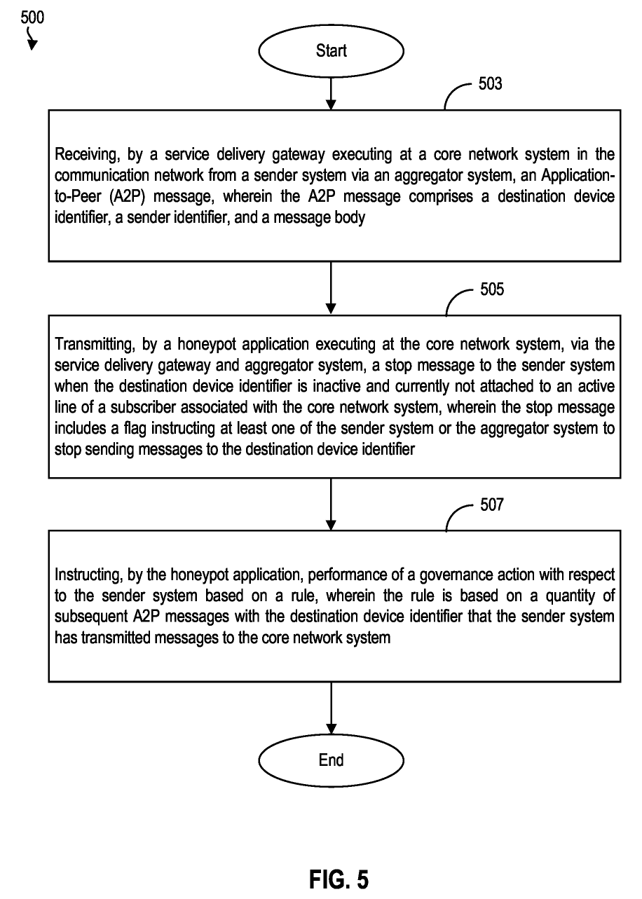

Referring now to FIG. 5, shown is a method 500 of inactive number message governance according to various embodiments of the disclosure. Method 500 may be performed by one or more network elements in the core network system 106 (e.g., the SDG 130 and the honeypot application 133). In embodiments, the method 500 may be implemented using a computer system with components as shown in FIG. 6. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At step 503, method 500 comprises receiving, by an SDG 130 executing at a core network system 106 in the communication network 100, from a sender system 109 via an aggregator system 112, an A2P message 205. The A2P message 205 comprises a destination device identifier (e.g., MSISDN 155), a sender identifier, and a message body. At step 505, method 500 comprises transmitting, by a honeypot application 133 executing at the core network system 106, via the SDG 130 and aggregator system 112, a stop message 220 to the sender system 109 when the destination device identifier is inactive and currently not attached to an active line of a subscriber associated with the core network system 106. In an embodiment, the stop message 220 includes a flag instructing at least one of the sender system 109 or the aggregator system 112 to stop sending messages 305 to the destination device identifier. At step 507, method 500 comprises instructing, by the honeypot application 133, performance of a governance action 324 with respect to the sender system 109 based on a rule 168. The rule 168 is based on a quantity of subsequent A2P messages 305 with the destination device identifier that the sender system 109 has transmitted messages to the core network system 106.

Method 500 may include other steps and/or features that are not otherwise shown in FIG. 5. In an embodiment, method 500 may further comprise querying, by the SDG 130, a state data store 151 to determine that a state 157 of the destination MSISDN 155 indicates that the destination MSISDN 155 is inactive and currently not attached to the active line of the subscriber associated with the core network system 106. In an embodiment, method 500 may further comprise logging, by a honeypot application 133 executing at the core network system 106, in an incoming message log 162 stored at a data store, metadata 218 associated with the A2P message 205 and an indication that the A2P message 205 is destined for an inactive destination MSISDN 155.

In an embodiment, method 500 may further comprise receiving, by the SDG 130, one or more subsequent A2P messages 305 after the stop message 220 is transmitted to the at least one of the sender system 109 or the aggregator system 112, in which the one or more subsequent A2P messages 305 comprise the destination MSISDN 155, and the governance action 324 is based on the one or more subsequent A2P messages 305. In an embodiment, method 500 may further comprise determining, by the honeypot application 133, the governance action 324 to perform with respect to the sender system 109 based on the rule 168, in which the rule 168 indicates that when the sender system 109 previously received the stop message 220 for the destination MSISDN 155 and the destination MSISDN 155 is indicated in an inactive MSISDN list 166, the governance action 324 comprises blocking all messages received from at least one of the sender system 109 or the aggregator system 122.

In an embodiment, method 500 may further comprise determining, by the honeypot application 133, the governance action 324 to perform with respect to the sender system 109 based on the rule 168, in which the rule 168 indicates that when the sender system 109 previously received at least a threshold quantity of stop messages 220 with the destination MSISDN 155, the governance action 324 comprises imposing rate limits on messages received from the sender system 109. In an embodiment, method 500 may further comprise determining, by the honeypot application 133, the governance action 324 to perform with respect to the sender system 109 based on the rule 168, in which the rule 168 indicates that when sender system 109 previously received over a threshold quantity of stop messages 220 with the destination MSISDN 155, the governance action 324 comprises reducing a reputation score of the sender system 109 based a quantity of prior stop messages 220 with the destination MSISDN 155 previously sent to the sender system 109, wherein the reputation score of the sender system 109 affects a transmission priority of messages received from the sender system 109.

FIG. 6 illustrates a computer system 380 suitable for implementing one or more embodiments disclosed herein. In an embodiment, the sender system 109, aggregator system 112, UE 103, SDG 130, and/or honeypot application 133 may each be implemented as the computer system 380. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication network to govern message transmissions to inactive numbers, wherein the method comprises:
receiving, by a service delivery gateway executing at a core network system in the communication network from a sender system via an aggregator system, an Application-to-Peer (A2P) message, wherein the A2P message comprises a destination Mobile Station International Subscriber Directory Number (MSISDN), a sender identifier, and a message body;
querying, by the service delivery gateway, a state data store to determine that a status of the destination MSISDN indicates that the destination MSISDN is inactive and currently not attached to an active line of a subscriber associated with the core network system;
logging, by a honeypot application executing at the core network system, in an incoming message log stored at a data store, metadata associated with the A2P message and an indication that the A2P message is destined for an inactive destination MSISDN;
transmitting, by the honeypot application via the service delivery gateway and aggregator system, a stop message to the sender system, wherein the stop message includes a request for at least one of the sender system or the aggregator system to stop sending messages to the destination MSISDN;
receiving, by the service delivery gateway from the sender system via the aggregator system, a subsequent A2P message after transmitting the stop message, wherein the subsequent A2P message comprises the destination MSISDN;
determining, by the honeypot application, a governance action to perform with respect to the sender system based on a rule after receiving the subsequent A2P message, wherein the rule is based on a quantity of subsequent A2P messages comprising the destination MSISDN received from the sender system and indicated in the incoming message log; and
instructing, by the honeypot application, performance of the governance action with respect to the sender system.

2. The method of claim 1, further comprises adding, by the honeypot application, a second indication in the incoming message log indicating that the sender system ignored an inactive MSISDN list including the destination MSISDN, wherein the inactive MSISDN list is stored at a database accessible by the sender system.

3. The method of claim 1, wherein the governance action comprises at least one of:
generating, by the honeypot application, a report detailing one or more subsequent A2P messages received after transmitting the stop message,
blocking, by the honeypot application, all messages received from at least one of the sender system or the aggregator system,
imposing, by the honeypot application, rate limits on messages received from the sender system;
invoicing, by the honeypot application, a penalty charge to the sender system for continued transmission of A2P messages to the inactive destination MSISDN, or
reducing, by the honeypot application, a reputation score associated with the sender system.

4. The method of claim 1, wherein the state data store comprises a plurality of MSISDNS and an associated active status or inactive status for each of the MSISDNs, wherein when an MSISDN is associated with an active status, the MSISDN is currently attached to the active line of the subscriber, and wherein when the MSISDN is associated with the inactive status, the MSISDN is currently not attached to the active line of the subscriber.

5. The method of claim 1, wherein the stop message comprises a flag indicative that the stop message is the request for at least one of the sender system or the aggregator system to stop sending messages to the destination MSISDN.

6. A core network system, comprising:
one or more memories;
one or more processors coupled to the one or more memories;
a service delivery gateway stored at one or more of the one or more memories, which when executed by one or more of the one or more processors, causes the service delivery gateway to be configured to:
receive an Application-to-Peer (A2P) message from a sender system via an aggregator system, wherein the A2P message comprises a destination Mobile Station International Subscriber Directory Number (MSISDN), a sender identifier, and a message body; and
determine, using a state data store, a status of the destination MSISDN, wherein the status of the destination MSISDN indicates that the destination MSISDN is inactive and currently not attached to an active line of a subscriber; and
a honeypot application stored at one or more of the one or more memories, which when executed by one or more of the one or more processors, causes the service delivery gateway to be configured to:
log, in an incoming message log stored at a data store, metadata associated with the A2P message and an indication that the A2P message is destined for an inactive destination MSISDN; and
transmit, via the service delivery gateway and aggregator system, a stop message to the sender system, wherein the stop message includes a flag instructing at least one of the sender system or the aggregator system to stop sending messages to the destination MSISDN.

7. The core network system of claim 6, wherein the service delivery gateway is further configured to receive one or more subsequent A2P messages after the stop message is transmitted to the at least one of the sender system or the aggregator system, wherein the one or more subsequent A2P messages comprise the destination MSISDN.

8. The core network system of claim 7, wherein the honeypot application is further configured to:
determine that the sender system previously received the stop message for the destination MSISDN;
determine that the destination MSISDN is indicated in an inactive MSISDN list;
determine a governance action to perform with respect to the sender system based on a rule, wherein the rule indicates that when the sender system previously received the stop message for the destination MSISDN and the destination MSISDN is indicated in the inactive MSISDN list, the governance action comprises blocking all messages received from at least one of the sender system or the aggregator system; and
perform the governance action with respect to the sender system.

9. The core network system of claim 6, wherein the honeypot application is further configured to:
determine that the sender system previously received at least a threshold quantity of stop messages indicating the destination MSISDN;
determine a governance action to perform with respect to the sender system based on a rule, wherein the rule indicates that when sender system previously received at least the threshold quantity of stop messages with the destination MSISDN, the governance action comprises imposing rate limits on messages received from the sender system; and
perform the governance action with respect to the sender system.

10. The core network system of claim 6, wherein the honeypot application is further configured to:
determine that the aggregator system previously received at least a threshold quantity of stop messages for the destination MSISDN;
determine a governance action to perform with respect to the aggregator system based on a rule, wherein the rule indicates that when aggregator system previously received at least the threshold quantity of stop messages for the destination MSISDN, the governance action comprises imposing rate limits on messages received from the aggregator system; and
perform the governance action with respect to the aggregator system.

11. The core network system of claim 6, wherein the incoming message log includes metadata describing all incoming messages received by the service delivery gateway, wherein the incoming message log includes an inactive destination message log including metadata describing all incoming messages with an inactive destination MSISDN.

12. The core network system of claim 6, wherein the state data store comprises a plurality of MSISDNS and an associated active status or inactive status for each of the MSISDNs, wherein when an MSISDN is associated with an active status, the MSISDN is currently attached to the active line of the subscriber, and wherein when the MSISDN is associated with the inactive status, the MSISDN is currently not attached to the active line of the subscriber.

13. The core network system of claim 6, wherein the honeypot application is further configured to record, in an outgoing stop message log stored at the data store, metadata describing the stop message, wherein the metadata describing the stop message comprises at least one of an identifier of the sender system, an identifier of the aggregator system, or a timestamp of sending the stop message.

14. A method, comprising:
receiving, by a service delivery gateway executing at a core network system in a communication network from a sender system via an aggregator system, an Application-to-Peer (A2P) message, wherein the A2P message comprises a destination device identifier, a sender identifier, and a message body;
transmitting, by a honeypot application executing at the core network system, via the service delivery gateway and aggregator system, a stop message to the sender system when the destination device identifier is inactive and currently not attached to an active line of a subscriber associated with the core network system, wherein the stop message includes a flag instructing at least one of the sender system or the aggregator system to stop sending messages to the destination device identifier; and
instructing, by the honeypot application, performance of a governance action with respect to the sender system based on a rule, wherein the rule is based on a quantity of subsequent A2P messages with the destination device identifier that the sender system has transmitted messages to the core network system.

15. The method of claim 14, further comprising querying, by the service delivery gateway, a state data store to determine that a status of the destination device identifier indicates that the destination device identifier is inactive and currently not attached to the active line of the subscriber associated with the core network system 106.

16. The method of claim 14, further comprising logging, by a honeypot application executing at the core network system, in an incoming message log stored at a data store, metadata associated with the A2P message and an indication that the A2P message is destined for an inactive destination device identifier.

17. The method of claim 14, further comprising receiving, by the service delivery gateway, one or more subsequent A2P messages after the stop message is transmitted to the at least one of the sender system or the aggregator system, wherein the one or more subsequent A2P messages comprise the destination device identifier, and wherein the governance action is based on the one or more subsequent A2P messages.

18. The method of claim 14, further comprising determining, by the honeypot application, the governance action to perform with respect to the sender system based on the rule, wherein the rule indicates that when the sender system previously received the stop message for the destination device identifier and the destination device identifier is indicated in an inactive MSISDN list, the governance action comprises blocking all messages received from at least one of the sender system or the aggregator system.

19. The method of claim 14, further comprising determining, by the honeypot application, the governance action to perform with respect to the sender system based on the rule, wherein the rule indicates that when the sender system previously received at least a threshold quantity of stop messages with the destination device identifier, the governance action comprises imposing rate limits on messages received from the sender system.

20. The method of claim 14, further comprising determining, by the honeypot application, the governance action to perform with respect to the sender system based on the rule, wherein the rule indicates that when sender system previously received over a threshold quantity of stop messages with the destination device identifier, the governance action comprises reducing a reputation score of the sender system based a quantity of prior stop messages with the destination device identifier previously sent to the sender system, wherein the reputation score of the sender system affects a transmission priority of messages received from the sender system.
